(19) United States
(12) Patent Application Publication
(10) Pub. No.: US 2025/0128921 A1
(43) Pub. Date: Apr. 24, 2025

(54) PORTABLE POWER-DRIVEN SYSTEM

(71) Applicant: SKYLOTEC GmbH, Neuwied (DE)

(72) Inventors: Alexey Binogerov, Neuwied (DE); Dmitriy Silin, Neuwied (DE); Jimmy Eiterjord, Neuwied (DE)

(21) Appl. No.: 18/918,657

(22) Filed: Oct. 17, 2024

(30) Foreign Application Priority Data
Oct. 20, 2023 (EP) 23204983.3

(51) Int. Cl. B66D 1/74

(52) U.S. Cl. CPC B66D 1/7489; B66D 1/7415; B66D 1/7447

(57) ABSTRACT

The present disclosure relates to a portable power-driven system for advancing a rope, wherein the portable power-driven system is provided with a specifically designed dual-function cover member provided for improving operational safety of the portable power-driven system.

### CROSS-REFERENCE TO RELATED APPLICATIONS

The present application is based upon and claims the right of priority to EP patent application Ser. No. 23/204,983.3, filed Oct. 20, 2023, the disclosure of which is hereby incorporated by reference herein in its entirety for all purposes.

### TECHNICAL FIELD

The present disclosure relates to a portable power-driven system for advancing a rope, wherein the portable power-driven system is provided with a specifically designed dual-function cover member provided for improving operational safety of the portable power-driven system.

### BACKGROUND OF THE PRESENT DISCLOSURE

Powered personal lifting devices assist personnel in scaling vertical surfaces. Motorized winches are used to raise or lower personnel on platforms or harnesses attached to ropes. A winch must be anchored to a solid platform above the load or use pulleys coupled to the platform to hoist the load. Further, a winch winds the rope or cable on a spool which limits the length and weight of rope that can be used. Hoists, usually with compound pulleys or reducing gears, are used to raise or lower individuals or platforms and must be suspended from a secure support point such as a tripod, beam or bridge crane. Typically, a winch or hoist requires at least a second person to operate or control the device in order for a first person to safely ascend a rope.

However, there are many scenarios where it would be desirable to have access to a portable winch, preferably one that can be operated by the person ascending or descending the rope. Such scenarios include for example mountain climbing, caving, tree trimming, rescue operations and military operations. Industrial uses of a climbing device may include scaling tall structures, towers, poles, mine shafts or bridge works for servicing, cleaning, window washing, painting, etc.

An example of such a portable winch is disclosed in U.S. Pat. No. 9,731,945. In U.S. Pat. No. 9,731,945 there is provided a promising approach to a portable climber operated winch, denoted as a power-driven system, where the power-driven system comprises a motor, the motor comprising a drive shaft, a rope grab configured to receive the rope, the rope grab connected to the drive shaft of the motor for rotation of the rope grab, and a hinged safety arrangement comprising a safety lid configured to be arranged in a closed state to fully cover the rope grab during operation of the power-driven system, and to be arranged in an opened state for allowing introduction of the rope to the rope grab. During operation of the portable power-driven system, and once the motor is engaged and starts to rotate, the rope grab may advance the climber in a typically vertical direction along the rope.

Even though the above-mentioned prior art shows a very useful solution for rope access to heights, there is always an endeavor to introduce further improvements for the personnel utilizing the equipment. Specifically, it may in some situations be desirable to further simplify the operational process, as well as to allow for an increase multitude of differently formed ropes to be used together with the portable power-driven system.

### SUMMARY OF THE PRESENT DISCLOSURE

According to a first aspect of the present disclosure, the above is at least partly alleviated by a portable power-driven system for advancing a rope, the rope extending in a first main direction, the power-driven system comprising a main body comprising a motor, the motor comprising a drive shaft, a rope grab connected to the drive shaft, the rope grab comprises a rope engaging face having a concave form adapted to, during an operation of the power-driven system, engage the rope along a first section of a circumference of the rope grab, and a cover member rotatably connected to the main body and configured to be arranged in an opened state for allowing introduction of the rope to the rope grab and to be transitioned to a closed state to cover the rope grab during the operation of the power-driven system, wherein the cover member comprises a first roller that is integrated in the cover member, the first roller being arranged to force the rope to engage with the rope grab when the cover member is in the closed state.

The present disclosure is based on the understanding that it may be possible to, compared to prior art, firstly simplify for a user how to correctly introduce the rope with the portable power-driven system and secondly to ensure that the portable power-driven system then can be operated in a safe manner.

This in accordance with the present disclosure at least partly achieved by arranging the portable power-driven system to comprise a specifically designed dual-function cover member provided for improving operational safety of the portable power-driven system. The cover member comprises is arranged to ensure that the rope grab cannot be “touched” while operating the portable power-driven system (e.g. when operating the portable power-driven system to provide a winch function). At the same time, the cover member comprises an integrated first roller that has been positioned at the cover member such that the integrated first roller “pushes” the rope towards the rope grab when the cover member is closed, with the purpose of ensuring a suitable friction between the rope grab and the rope once the rope grab is rotating.

The design inherently promotes user-friendliness. By simplifying the rope engagement process and enhancing safety features, the system reduces the learning curve for new users, making it accessible for individuals with varying levels of expertise.

By arranging the integrated first roller at the cover member, it is as understood from the above possible to “move away” the roller from the rope grab when “loading” the rope around a portion of the rope grab, i.e. when the cover member is in its opened state. Accordingly, the accessibility for the user when loading the rope is improved as compared to prior-art solutions employing similar rollers for ensuring the above-mentioned friction between the rope grab and the rope. By applying the scheme as is suggested in accordance to the present disclosure, the first roller will only be “interacting” with the rope once the cover member has been arranged at its closed state.

The integrated first and/or the second roller in the cover member may also be designed to include sensors or tactile elements that provide real-time feedback on the rope's tension and positioning, relative to the respective roller. This could offer an extra layer of operational safety by alerting the user or shutting down the system in case of rope slippage or other potential hazards.

Within the context of the application, the term roller should be interpreted broadly, and may comprise any type of device that can rotate “along with the rope” at the same time as the pressure is provided between the rope and the rope grab. Accordingly, the first roller should preferably be configured to provide a pressure that still allows the first roller to rotate during operation (rotation of) the rope grab.

As mentioned above, the motor is connected to the rope grab using the drive shaft. The expression “drive shaft” may include any mechanical implementation for transferring a rotational force from the motor to the rope grab. As such, the drive shaft may for example further include a gearbox or similar for adapting the rotational force to suit the rotational speed of the rope grab. The term rope is here used in its broader sense and is intended to include ropes, wires, belts, webbing, and cords of whatever nature or size suitable for engaging with the rope grab.

As understood by this definition, the rope may have a circular, elliptic of essentially flat (e.g. rectangular) form. In this regard, the concave form of the rope engaging face on the rope grab be designed to accommodate ropes of varying diameters and materials. This versatility enhances the system's adaptability, making it suitable for a wide range of applications beyond its primary function.

In a possible embodiment of the portable power-driven system, the rotation axis for the cover member, which is rotatably connected to the main body, is strategically aligned to be parallel to the drive shaft of the motor. This parallel alignment ensures a smooth and consistent rotational motion when transitioning the cover member between its closed and open states. Importantly, the cover member is designed to be rotated in a specific manner that allows it to ‘rotate away’ from the rope grab mechanism. This intentional design choice serves to expose the rope grab, making it readily accessible for the user. Such easy access facilitates efficient engagement of the rope with the rope grab, reducing the time and effort required to securely attach or detach the rope. In this configuration, not only is user convenience enhanced, but it also minimizes any obstruction or interference with the rope grab, thereby improving overall system performance and safety. Furthermore, the parallel alignment of the rotation axis for the rotatably connected cover member and the motor's drive shaft minimizes the system's spatial footprint. This efficient use of space makes the system highly portable and easier to integrate into various working environments.

Additionally, it may be preferred to arrange the cover member to comprise a first side facing towards the rope grab and a second opposite side facing away from the rope grab when the cover member is in the closed state, the first side comprising a circular segment matching a shape of a portion of the rope grab. Having such a shape may additionally allow for the rope to follow tightly with the rope grab, reducing the risk of any entanglement of the rope when arranged with the rope grab.

Preferably, the cover member is constructed from materials such as plastic, metal, or a combination of both. Other composite materials are also within the scope of the present disclosure. The selection of the material for the cover member is strategically made to balance the overall weight of the portable power-driven system, thereby enhancing its portability. At the same time, the chosen material aims to provide sufficient durability to ensure the system's longevity without unwanted downtime. Importantly, the material of the cover member could also be specifically selected to offer high resistance to environmental factors. This includes, but is not limited to, resistance to corrosion, moisture, and UV exposure. Such resistance not only extends the lifespan of the system but also minimizes maintenance needs, thereby adding another layer of operational efficiency and reliability.

Furthermore, in some embodiment it may be desirable to allow the portable power-driven system to also comprise a second roller adapted to guide the rope in relation to the rope grab. The second roller is typically arranged for guiding the rope on an unloaded side of the rope grab, whereas the first roller is arranged on a loaded side of the rope grab, i.e. relative to a fixed point provided in relation to the rope. The fixed point of the rope may for example be above the portable power-driven system if operating the portable power-driven system in a vertical manner. The same of course account for a situation where the portable power-driven system is operated in an essentially horizontal manner, with one fixed end of the rope and once “loose end”. An advantage with the second roller is for example to be able to ensure that the loose end of the rope is flowing (entering or leaving, depending on a rotational direction of the rope grab) in a swift manner relative to the rope grab.

In one advantageous embodiment of the present disclosure, the second roller comprises a spring mechanism. This spring mechanism bestows upon the second roller a level of flexibility relative to the rope grab, thereby enabling a more fluid and swift operation of the loose end of the rope when interacting with the rope grab. The inherent flexibility 15 provided by the spring mechanism further serves to actively push the rope into the groove of the rope grab, thus significantly strengthening the engagement between the rope and the rope grab.

Furthermore, the second roller may also provide for an improved friction between the rope and the rope grab when the portable power-driven system is operated in a downward manner. The second roller will then function to push the rope into the rope grab, such that said friction therebetween is increased.

Moreover, the incorporation of a spring mechanism offers an added layer of adaptability, allowing the system to better accommodate ropes of varying tensile strengths and diameters. This feature enhances the system's versatility, making it suitable for a broader range of applications.

Additionally, the spring mechanism could be equipped with a damping feature to mitigate sudden forces or shocks exerted on the rope, thereby providing a smoother and safer operational experience. This damping feature would also prolong the lifespan of both the rope and the rope grab by reducing wear and tear.

It may in some embodiments be possible to allow the first roller to be implemented as a bearing. It should be understood that the expression bearing may include different types of bearings. Here, an outer surface of the bearing will “push” the rope towards the rope grab and to ensure that the rope engages with the rope grab when the cover member is in the closed state. Possibly, also the second roller may be selected with the above in mind.

Advantageously, the portable power-driven system is further enhanced by incorporating a securing member that is meticulously adapted to automatically lock the cover member to the main body once the cover member has fully transitioned to its closed state. This automatic locking feature adds a critical layer of operational safety by ensuring that the system cannot be accidentally activated when the cover is not securely in place.

In an especially advantageous embodiment, the system integrates a “double lock” mechanism, a feature ensuring that the motor remains inoperative unless both portions of the double lock are fully engaged. This two-stage locking procedure offers a heightened level of security, virtually eliminating the possibility of accidental or unauthorized activation of the system.

Furthermore, the double lock mechanism can be designed to provide auditory or visual cues, such as a ‘click’ sound or an LED indicator, to confirm that both locking stages are successfully engaged. This immediate feedback adds to user confidence and ensures proper operation. Additionally, the double lock mechanism contributes to overall system robustness by providing redundancy. In the unlikely event that one portion of the lock fails or is compromised, the other can still serve as a fail-safe, thereby maintaining a degree of operational safety. Still further, the inclusion of a double lock mechanism could be advantageous from a regulatory compliance standpoint. By offering multiple layers of safety, the system is more likely to meet or exceed various safety standards, thereby facilitating its adoption across different markets and applications.

Additionally, it may in line with the present disclosure be possible to arrange the portable power-driven system to further comprise a user interface for operating the motor for allowing rotation of the rope grab in a first and a second direction. Here, the first direction may for example ensure that the portable power-driven system is travelling upwards when the main direction, as introduced above, it essentially a vertical direction, and the second direction ensures that the portable power-driven system is travelling downwards. The user interface may for example include a button or any other element useful for operating the motor of the portable power-driven system.

In addition, the portable power-driven system may further comprise wireless reception means configuring the system to be controlled from a distance using for example a remote control, thus allowing for example a second operator to control the portable power-driven system from a distance.

Generally, for operating the portable power-driven system, it is desirable to arrange the portable power-driven system to further comprise a sling connected to the anchoring point, the sling arranged to receive at least one of a maillon, a carabiner, or a rigging plate. The sling may for example be of a textile material. The elongated sling is preferably at one of its ends connected to the anchoring point and configured to at its other end receive at least one of a maillon, a carabiner, or a rigging plate. The at least one of a maillon, a carabiner, or a rigging plate may then in turn be used for allowing connection of the portable system to e.g. a harness for a user, or for anchoring the system to a fixed structure using e.g. further climbing/fining equipment. The general term “elongated sling” is typically referred to as in relation to general climbing equipment. In addition, the term “textile” should be interpreted very broadly. For example, the textile material used for forming the sling may be of any type of e.g. woven or non-woven material, natural and/or synthetic fibers, etc. During operation of the portable power-driven system, the user is typically securely connected to the above discussed anchoring point, e.g. by means of the sling and carabiner.

In a preferred embodiment of the present disclosure, the motor is an electrical motor, preferably but non-necessarily coupled to a gearbox designed to optimize rotational speed and torque. The power-driven system further comprises a rechargeable battery for supplying electrical power to the motor. In an alternative embodiment, the motor could be a petrol engine, which may or may not be used in conjunction with a gearbox, depending on the desired operational characteristics.

Preferably, the portable power-driven system further comprises a brake mechanism arranged to reduce a rotation of the motor when the motor is deactivated, and a control member adapted to electrically or manually disengage the brake mechanism. Such a brake mechanism is strategically arranged to reduce the rotation of the motor when the motor is deactivated. This brake mechanism may be hydraulic, mechanical, or electromechanical in nature, and is specifically designed to quickly and safely bring the motor to a standstill or to a reduced rotational speed. Additionally, the system includes a control member that is adapted to either electrically or manually disengage the brake mechanism. The control member could be a switch, lever, or even a software interface, allowing the user flexibility in how they interact with the brake mechanism. In certain embodiments, the control member can also be programmed to automatically disengage the brake mechanism under predefined conditions, such as reaching a certain battery level or upon receiving a remote signal.

In one alternative embodiment of the portable power-driven system, the system is equipped with at least one resistive element, such as a resistor or a resistive coil, that is selectively electrically connected to the electrical motor. This connection is made specifically when the control member is in the process of disengaging the brake mechanism. The purpose of this resistive element could be to act as a load dump, absorbing excess electrical energy generated by the motor, thereby facilitating a smoother and more controlled deceleration. The resistive element may be automatically activated through electronic control systems or may require manual input from the user. In some instances, the resistive element may also serve additional functions, such as converting the absorbed electrical energy into heat, which could be utilized for other system functionalities.

Preferably, the portable power-driven system further includes a hold mechanism specifically adapted to automatically secure the cover in a stable position relative to the main body of the system when the cover member is in the open state. Among the various methods to achieve this stability, a spring plunger mechanism stands out as a particularly effective and user-friendly option. The spring plunger, which may be activated upon opening the cover, engages with a corresponding socket or groove on the main body to hold the cover securely in place. This ensures a reliable hold with the benefit of quick and easy manual disengagement when needed. Other methods such as magnetic latching, a ratcheting mechanism, or a hydraulic arm may also be employed. In some embodiments, the hold mechanism could be equipped with a sensor that sends a signal to a control unit, indicating that the cover is securely held in the open position, which may trigger other system functionalities or safety features.

Further features of, and advantages with, the present disclosure will become apparent when studying the appended claims and the following description. The skilled addressee realize that different features of the present disclosure may be combined to create embodiments other than those described in the following, without departing from the scope of the present disclosure.

### BRIEF DESCRIPTION OF THE DRAWINGS

The various aspects of the present disclosure, including its particular features and advantages, will be readily understood from the following detailed description and the accompanying drawings, in which:

FIG. 1 conceptually illustrates a portable power-driven system according to embodiments of the present disclosure;

FIGS. 2A-2D show conceptual side views and detailed illustrations of an exemplary portable power-driven system provided in relation to embodiments of the present disclosure, and

FIGS. 3A and 3B illustrates exemplary horizontal and vertical operations of the portable power-driven system according to the present disclosure.

### DETAILED DESCRIPTION

The present disclosure will now be described more fully hereinafter with reference to the accompanying drawings, in which currently preferred embodiments of the present disclosure are shown. This present disclosure may, however, be embodied in many different forms and should not be construed as limited to the embodiments set forth herein; rather, these embodiments are provided for thoroughness and completeness, and fully convey the scope of the present disclosure to the skilled addressee. Like reference characters refer to like elements throughout.

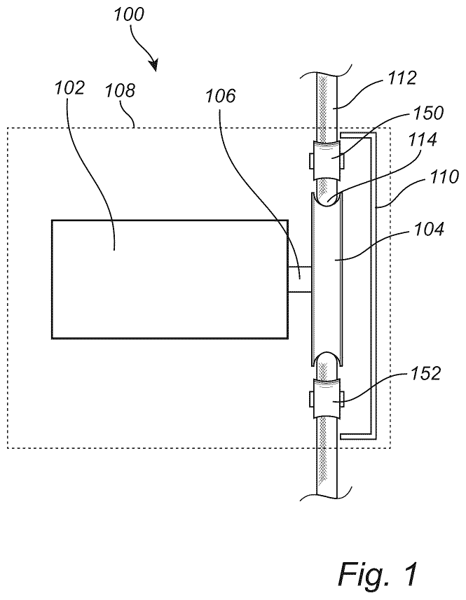

Referring now to the drawings and to FIG. 1 in particular, there is depicted a portable power-driven system 100 according to a possible embodiment of the invention. The portable power-driven system 100 comprises a motor 102 and a rope grab 104, the motor 102 and the rope grab 104 being connected to each other by means of for example a drive shaft 106 (possibly also including a gearbox or similar). The motor is preferably an electrical motor further comprising a rechargeable battery but could alternatively be substituted with an internal combustion engine. In the illustrated embodiment a drive shaft 106 is enclosed in a main body 108 of the system 100. The portable power-driven system 100 further comprises a cover 110 for covering the rope grab 104.

The rope grab 104 is in line with the present disclosure configured for receiving and advancing a rope 112 once the motor 102, by means of the drive shaft 106, rotates the rope grab 104. The rope grab 104 has, preferably, an essentially circular shape, incorporating a rope engaging face 114 of concave form. This concave form, strategically arranged at the circumference of the rope grab, is optimally configured to be somewhat rounded, resembling a “U-shape”. However, the design also allows for the versatility of adopting a “V-shaped” rope engaging face 114, depending on specific application needs or rope characteristics. In a currently preferred embodiment, the rope grab boasts a diameter of approximately 50 mm, although this dimension may be adapted based on the particular rope being used and the overall design considerations of the portable power-driven system 100.

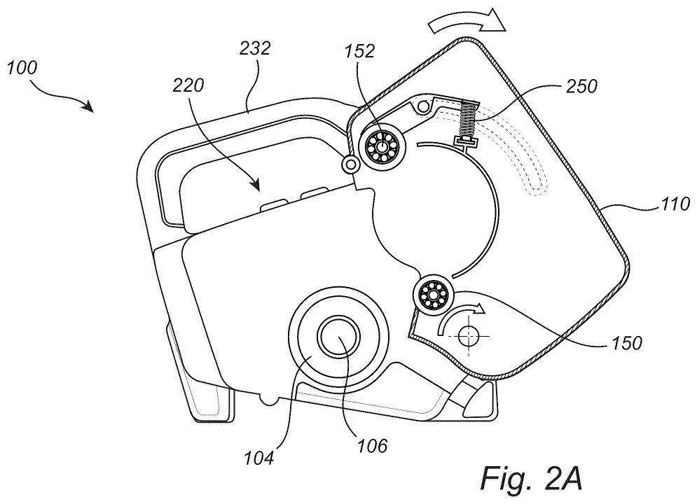

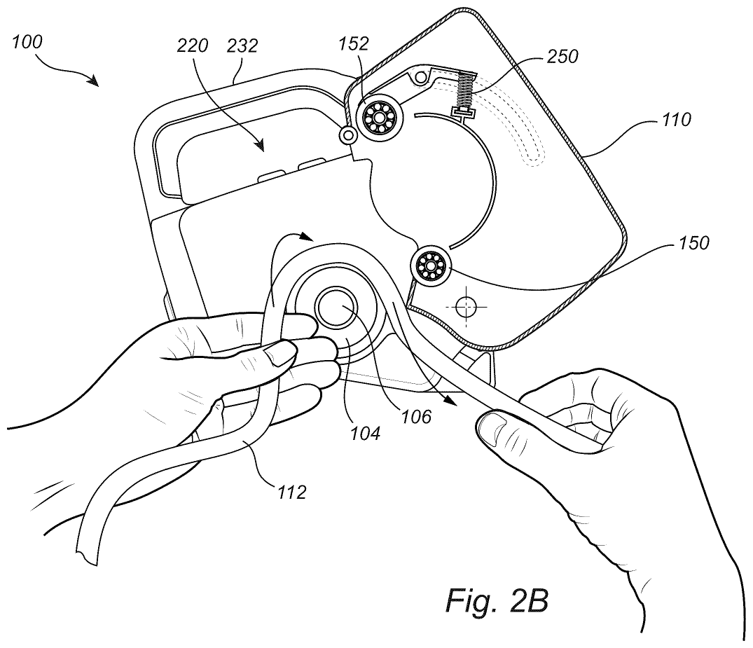

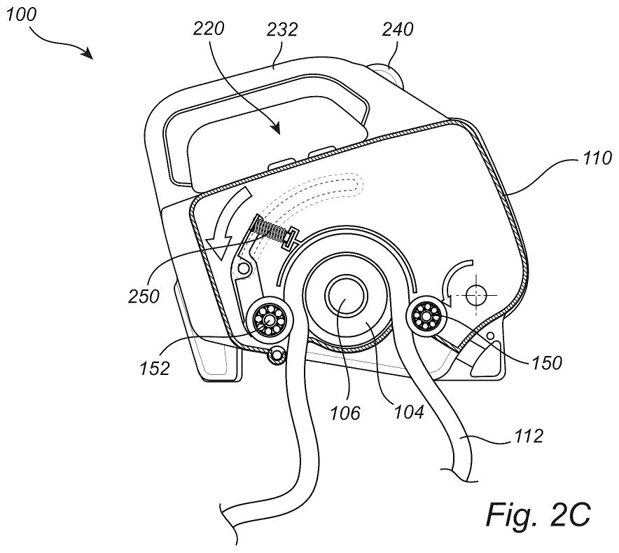

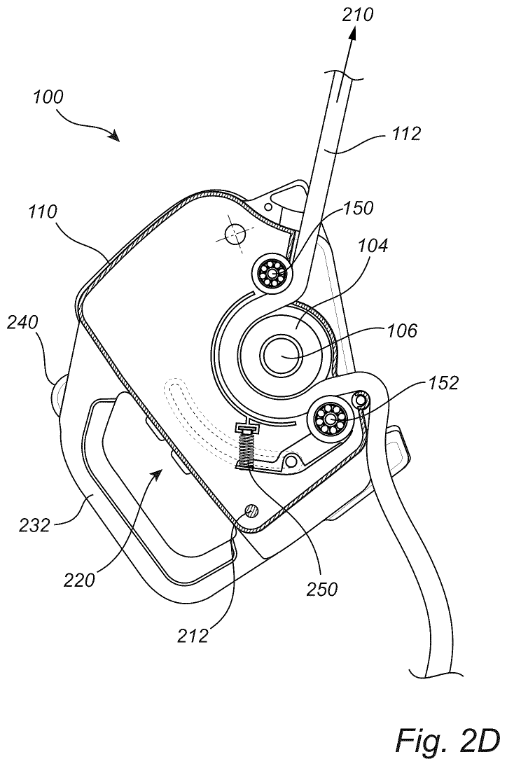

As have been previously discussed, the cover 110 can transition from an open state (as further shown in FIGS. 2A and 2B) and in a closed state (as is shown in FIG. 2C).

When in its open state, the cover 110 is held securely in position by a specialized hold mechanism (not explicitly illustrated). As previously discussed, this hold mechanism could employ a spring plunger, magnetic latching, or hydraulic arms, thereby providing both security and flexibility. The hold mechanism may further, in some embodiments, be enhanced by a sensor that confirms the cover's position, either sending a signal to a control unit arranged onboard the portable power-driven system 100, or for providing visual or auditory feedback to a user of the portable power-driven system 100.

The cover 110 is strategically aligned with its rotation axis parallel to the drive shaft 106. This parallel arrangement ensures a smooth and consistent rotational motion, aiding in the seamless transition between the cover's 110 open and closed states. It minimizes spatial footprint and adds to the portable power-driven system's 100 case of use, especially when space is constrained.

As previously elaborated, the cover 110 may be fabricated from plastic, metal, or a composite material that balances the system's overall weight while providing durability and resistance to environmental factors like corrosion, moisture, and UV exposure.

With further reference to FIGS. 2A-2D, in the design of the present disclosure, a key feature is the integration of two rollers within the cover 110, namely a first roller 150 and a second roller 152. These rollers are integral parts of the cover 110. When the cover 110 is in its closed state, the first roller 150 is positioned to actively push the rope 112 into the rope engaging face 114 of the rope grab 104. This ensures a secure engagement between the rope 112 and the rope grab 104, thereby reducing the likelihood of rope slippage during operation. Furthermore, both rollers 150, 152 preferably comprise bearings, which contribute to smooth rotation when the rope 112 is moving, additionally reducing friction with the rope 112, thereby improving operational efficiency of the portable power-driven system 100.

When the cover 110 transitions to its open state, i.e. as shown in FIGS. 2A and 2B, the integrated rollers 150, 152 are designed to retract or move away from the rope grab 104. This provides unobstructed access for the rope 112 to be easily introduced around the rope grab 104, thereby simplifying the process of “loading” the portable power-driven system 100 for operation.

Additionally, the second roller 152 includes a spring mechanism 250, providing a degree of flexibility relative to the rope grab 104. This spring mechanism 250 serves to absorb sudden forces or shocks on the rope, contributing to a smoother operational experience and reducing wear on both the rope 112 and the rope grab 104.

The integrated rollers 150, 152 in the cover 110 serve dual functions, namely, to ensure a secure and efficient engagement between the rope grab 104 and the rope 112 when the cover 110 is closed, and further facilitates easy loading of the rope 112 when the cover 110 is open. This contributes to the portable power-driven system 100 being operated in a safe, efficient, and user-friendly manner.

During operation, with specific reference to FIGS. 2B, 2C and 2D, the rope 112 is inserted to engage with a portion of the rope grab 104, typically being in contact with around half of the circumference of the rope grab 104. The rope 112 will in addition extend in a first main direction 210 and as such engage with the first roller 150 which, when the cover 110 is in the closed state, will force the rope 112 towards the rope grab 104, such that the rope 112 is at least partly “clamped” between the first roller 150 and the rope grab 104. Accordingly, as a force is provided to the rope 112 at a portion of the rope grab 104 where the rope 112 during operation of the portable power-driven system 100 is engaged, an increased friction between the rope 112 and the rope grab 104 may be provided. This will, as mentioned above, allow for the use of a large variety of different types of ropes to be used with the portable power-driven system 100.

Still further, the rope 112 will pass also the second roller 152 before exiting the portable power-driven system 100, at the loose and unloaded end of the rope 112. The second roller 152 will at least partly control how the rope 112 interacts with the rope grab 104, with the purpose of ensuring that the rope 112 flows well with the rope grab 104 when operating the portable power-driven system 100. As discussed above, the second roller 152 will also function to increase the friction between the rope 112 and the rope grab 104 when operating the portable power-driven system 100 downwards.

When operating the portable power-driven system 100, as exemplified in FIG. 2D with the cover 110 closed, a load will be connected to an anchoring point 212 of the portable power-driven system 100. The anchoring point 212, for example implemented with a hardened steel element, may be provided with for example a sling in turn connected to a maillon for connecting to a harness of a user. The user will accordingly place a loading force to the portable power-driven system 100, where the loading force will extend in an essentially opposite direction as compared to the main direction 210 of the rope 112.

Furthermore, the cover 110 incorporates a safety mechanism, which operates in tandem with a “double lock” feature 220. This dual stage locking ensures that the motor 102 remains inoperative unless both locks are fully engaged, thereby significantly enhancing operational safety. A sensor, in some embodiments, within the locking mechanism could be programmed to confirm that both stages are securely locked before allowing the motor 102 to operate, thus eliminating the risk of accidental activation.

In a further possible embodiment, the portable power-driven system 100 is equipped with a handle 232, strategically positioned to facilitate easy transportation of the portable power-driven system 100. The handle is ergonomically designed to ensure a comfortable grip, making it effortless to carry the system to various operational sites.

Additionally, the portable power-driven system 100 is provided with a user interface 240 for intuitive control of the motor 102. The user interface 240 is tailored to the specific type of motor employed, e.g. if electrical or internal combustion based, and may include a variety of control elements such as buttons, switches, or even a touchscreen interface for more advanced control options.

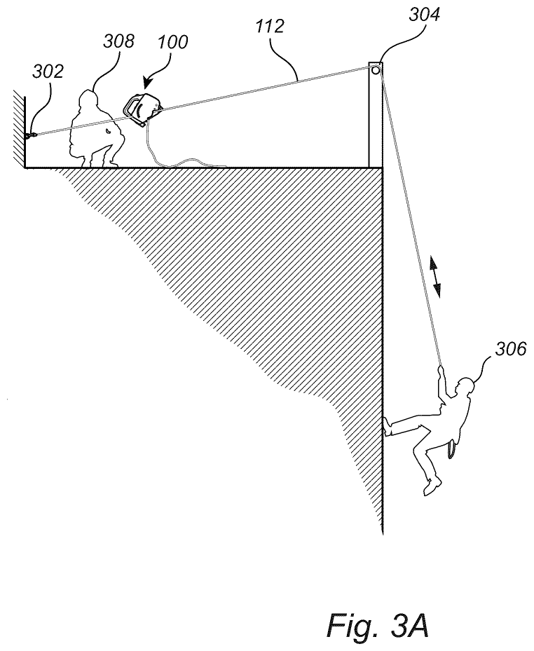

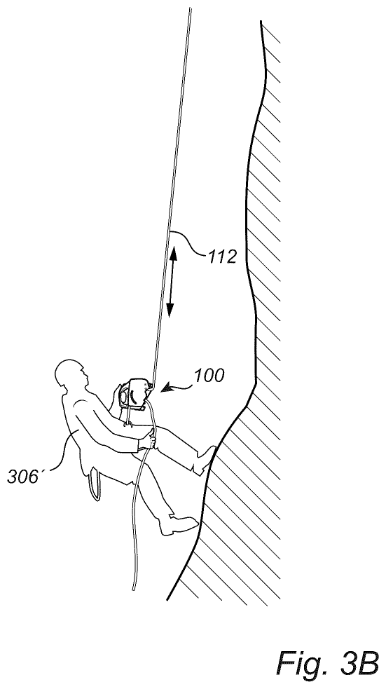

Turning now to FIGS. 3A and 3B, which illustrates the exemplary horizontal and vertical operation, respectively, of the portable power-driven system 100. In the embodiment of FIG. 3A, the portable power-driven system 100 is arranged as a standalone winch mode, i.e. instead of the user connecting his/her safety harness directly to the anchoring point and using the portable power-driven system 100 to ascend/descend along the rope 112, the portable power-driven system 100 is in this mode connected to a fixed structure 302 such as a wall or similarly available object at the operational site.

In the illustrated example, the rope 112 is configured to pass over e.g. a roller 304 for the purpose of allowing a user 306 to be transported in a vertical manner without having to himself control the portable power-driven system 100. The portable power-driven system 100 may instead (or also) be controlled by an operator 308 using a user interface (not shown), the operator 308 typically situated adjacently to the portable power-driven system 100. It may however be possible to configure the portable power-driven system 100 to additionally comprise means to be controlled from a distance, for example by means of a remote control (wired or wireless, not shown). Preferably, the control is wireless and in such an implementation the portable power-driven system 100 comprises wireless connection means to communicate wirelessly with the remote control.

In FIG. 3B, the typical vertical operation scenario for the portable power-driven system 100 is shown. In this scenario, the user 306′ having a safety harness is typically connected to the anchoring point of the portable power-driven system 100. The rope 112 will in this case typically be arranged at a position above the user 306′ (sometimes in relation to climbing denoted as “top rope”). FIG. 3B exemplifies the user 306′ being an arborist accessing a tree 312, where the arborist 306′ accesses the tree 312 from the ground level 314. During operation of the portable power-driven system 100, the user 306′ will operate the user interface for ascending/descending between the anchoring point and the ground level 314.

Although the figures may show a specific order of method steps, the order of the steps may differ from what is depicted. Also two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps. Additionally, even though the present disclosure has been described with reference to specific exemplifying embodiments thereof, many different alterations, modifications and the like will become apparent for those skilled in the art.

Variations to the disclosed embodiments can be understood and effected by the skilled addressee in practicing the claimed present disclosure, from a study of the drawings, the disclosure, and the appended claims. Furthermore, in the claims, the word “comprising” does not exclude other elements or steps, and the indefinite article “a” or “an” does not exclude a plurality.

1. A portable power-driven system for advancing a rope, the rope extending in a first main direction, the power-driven system comprising:
a main body comprising a motor, the motor comprising a drive shaft;
a rope grab connected to the drive shaft, the rope grab comprises a rope engaging face having a concave form adapted to, during an operation of the power-driven system, engage the rope along a first section of a circumference of the rope grab, and
a cover member rotatably connected to the main body and configured to be arranged in an opened state for allowing introduction of the rope to the rope grab and to be transitioned to a closed state to cover the rope grab during the operation of the power-driven system,
wherein the cover member comprises a first roller that is integrated in the cover member, the first roller being arranged to force the rope to engage with the rope grab when the cover member is in the closed state.

2. The portable power-driven system of claim 1, wherein a rotation axis for the rotatably connected cover member is parallel to the drive shaft.

3. The portable power-driven system of claim 1, further comprising a second roller, wherein the second roller is integrated with the cover and adapted to guide the rope in relation to the rope grab.

4. The portable power-driven system of claim 1, wherein the cover member comprises a first side facing towards the rope grab and a second opposite side facing away from the rope grab when the cover member is in the closed state, the first side comprising a circular segment matching a shape of a portion of the rope grab.

5. The portable power-driven system of claim 1, wherein the second roller comprises a spring mechanism.

6. The portable power-driven system of claim 1, wherein the first roller is a bearing.

7. The portable power-driven system of claim 1, wherein a shape of a circumference of the cover member matches a shape of a circumference of the main body.

8. The portable power-driven system of claim 1, wherein the cover member is formed from a plastic material, metal material or a combination of both.

9. The portable power-driven system of claim 1, further comprising a securing member adapted to automatically lock the cover member to the main body when the cover member has completely transitioned to the closed state.

10. The portable power-driven system of claim 1, further comprising a user interface for operating the motor for allowing rotation of the rope grab in a first and a second direction.

11. The portable power-driven system of claim 1, further comprising a sling connected to the anchoring point, the sling arranged to receive at least one of a maillon, a carabiner, or a rigging plate.

12. The portable power-driven system of claim 1, wherein the motor is an electrical motor and the power-driven system further comprises a rechargeable battery.

13. The portable power-driven system of claim 1, further comprising:
a brake mechanism arranged to reduce a rotation of the motor when the motor is deactivated, and
a control member adapted to electrically or manually disengage the brake mechanism.

14. The portable power-driven system of claim 1, further comprising at least one of a sensor and a tactile element arranged to provide information indicative of the rope's tension and/or positioning relative to the first or the second roller.

15. The portable power-driven system of claim 1, further comprising a hold mechanism adapted to automatically hold the cover in a stable position to the main body, when the cover member is in the open state.
